(19) United States
(12) Patent Application Publication
(10) Pub. No.: US 2011/0154117 A1
(43) Pub. Date: Jun. 23, 2011

(54) METHODS AND APPARATUS TO PERFORM LOG FILE ANALYSES

(75) Inventors: Jason David Danielson, Palatine, IL (US); Arun Viswanath, Hoffman Estates, IL (US)

(73) Assignee: GENERAL ELECTRIC COMPANY, A NEW YORK CORPORATION, Schenectady, NY (US)

(21) Appl. No.: 12/645,033

(22) Filed: Dec. 22, 2009

(51) Int. Cl. G06F 3/048; G06F 11/07; G06N 5/02

(52) U.S. Cl. 714/37; 715/764; 706/46; 714/E11.029

(57) ABSTRACT

Methods and apparatus to perform log file analyses are disclosed herein. An example method includes generating, by a processor, a plurality of data points by analyzing information in a log file; displaying one or more graphical representations of the data points; and in response to detecting an engagement of a first portion of a first one of the graphical representations, identifying a section of the log file corresponding to the engaged first portion and displaying the section of the log file in association with the graphical representations.

### FIELD OF THE DISCLOSURE

The present disclosure relates generally to information systems and, more particularly, to methods and apparatus to perform log file analyses.

### BACKGROUND

Most computing systems maintain log files to record activity performed by the computing systems and/or users thereof. A typical log file is a record of events (e.g., calculations, values, function calls, etc.) occurring in connection with one or more programs and/or in connection with one or more other operations of the computing system(s) for which the log files are maintained. The programs and/or files that generate the log files can be configured or customized to record any suitable information. Field engineers, technicians, programmers, and/or computing systems themselves utilize the information in the log files to, for example, diagnose a malfunctioning system, improve performance of a design, assess current operation(s), record one or more statistics, identify a source of a problem, etc.

### SUMMARY

An example computer implemented method includes generating, by a processor, a plurality of data points by analyzing information in a log file. Further, the example method includes displaying one or more graphical representations of the data points. Further, the example method includes, in response to detecting an engagement of a first portion of a first one of the graphical representations, identifying a section of the log file corresponding to the engaged first portion and displaying the section of the log file in association with the graphical representations.

An example tangible machine readable medium has instructions stored thereon that, when executed, cause a machine to generate a plurality of data points by analyzing information in a log file. Further, the example tangible machine readable medium has instructions stored thereon that, when executed, cause a machine to display one or more graphical representations of the data points. Further, the example tangible machine readable medium has instructions stored thereon that, when executed, cause a machine to, in response to detecting an engagement of a first portion of a first one of the graphical representations, identify a section of the log file corresponding to the engaged first portion and displaying the section of the log file in association with the graphical representations.

An example apparatus includes a module to obtain a plurality of data points from a server having one or more section analyzers that generate the data points by analyzing information in a log file. Further, the example apparatus includes a graphical user interface to display one or more graphical representations of the data points. Further, the example apparatus includes one or more graph associations to enable an engagement of a first portion of a first one of the graphical representations to cause an identification of a section of the log file corresponding to the engaged first portion and a display of the section of the log file in association with the graphical representations.

### BRIEF DESCRIPTION OF THE DRAWINGS

FIG. 1 is a block diagram of an example log analysis system including a log server and a plurality of workstations.

FIG. 2 is a block diagram of an example apparatus that may be used to implement of the example log viewer of FIG. 1.

FIG. 3 is an example sequence diagram illustrating example communications conveyed in the example log analysis system of FIG. 1.

FIG. 4 is a screenshot associated with an example implementation of the example log viewer of FIGS. 1 and/or 2.

FIG. 5 is a block diagram of an example apparatus that may be used to implement the example knowledge database of FIG. 1.

FIG. 6 is a flow diagram representative of example machine readable instructions that may be executed to implement the example knowledge base of FIGS. 1 and/or 5.

FIG. 7 is a block diagram of an example processor system that may be used to execute the machine readable instructions of FIG. 6 and/or to implement the example methods, apparatus, systems, and/or articles of manufacture described herein.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

While the example methods, apparatus, systems, and/or articles of manufacture are described herein in the context of healthcare information systems, the example methods, apparatus, systems, and/or articles of manufacture described herein can be implemented in connection with any suitable type of device and/or system associated with and/or implementing a log file system. That is, the healthcare information systems described herein are for purposes of illustration and not limitation. Different types of log file systems implemented in connection with different types of devices and/or systems can utilize the example methods, apparatus, systems, and/or articles of manufacture described herein to perform log file analysis.

Fields engineers, programmers, technical support personnel, and/or any other type of person interacting with a computing system (referred to herein collectively as “technicians”) and/or computing systems themselves utilize log files to analyze operation(s) of one or more programs and/or systems (e.g., to diagnose a problem, to find a cause of one or more errors, to assess an operation of one or more programs, etc.). Log files recording the operation(s) of even a simple program and/or system accumulate large amounts of information in short amounts of time and, thus, include vast quantities of data.

Reviewing large log files is time consuming and difficult as the information is highly statistical or technical information from which a problem and/or a cause of a problem are not readily discernable. For example, log files are typically limited to calculation results, request results, addresses, timestamps, etc. Furthermore, most log files are presented to technicians in textual form sorted by, for example, timestamps associated with different entries. Analyzing the log files in such a format is burdensome and often requires additional steps from the technicians (e.g., annotating the text of the log file and/or otherwise marking up the data) to make sense of or better understand the information.

The example methods, apparatus, systems, and/or articles of manufacture described herein improve technicians' ability to analyze log files. For example, the example methods, apparatus, systems, and/or articles of manufacture described herein provide a log viewer (e.g., communicated to a user via a graphical user interface (GUI)) capable of presenting one or more graphical representations of log data from one or more log files. As described in greater detail below, the example log viewer and the example graphical representations thereof enable technicians to rapidly identify areas of interest (e.g., a frequently occurring error, one or more flags, one or more alerts, and/or any other type of log entry) in the one or more log files. Furthermore, the example log viewer described herein conveys information to the technicians regarding the areas of interest. For example, in response to a user placing a cursor on a specific area of graph (e.g., a line graph representative of log file data), the example log viewer may display information (e.g., a textual entry in the log file including one or more indications of the corresponding log entry) related to that specific graph and/or a portion of the graph.

The example methods, apparatus, systems, and/or articles of manufacture described herein also provide technicians with a knowledge database for working with and utilizing log files. Generally, the example knowledge base described herein can assist technicians in, for example, diagnosing a problem using log file data and/or evaluating a potential solution for a problem identified using a log file. As described in greater detail below, the example knowledge base includes information regarding data patterns (e.g., of repeatedly occurring error messages in log file data) known to be associated with certain problems. These patterns can be recognized by the example knowledge base described herein and an indication of such recognition may be communicated to one or more technicians. In response to recognizing such pattern(s), the example knowledge base described herein may provide one or more potential causes of the related problem(s). As described below, the potential causes behind the recognized pattern(s) are defined in one or more mappings that can improve over time to reflect a collective expertise of a group of technicians contributing to the knowledge base. For example, technician(s) diagnosing one or more problems using the log files and receiving potential problem causes from the knowledge base may evaluate the accuracy of the suggestions and provide the evaluations to the knowledge base. In such instances, the knowledge base can be updated to reflect a positive or negative outcome according to the technician's evaluation.

Furthermore, the example knowledge base described herein includes information regarding potential or suggested solutions for problems that can also be communicated to technicians. Similar to the suggested problem causes described above, technicians can evaluate the performance of the potential or suggested solutions and provide the same to the example knowledge base described herein. Therefore, the example knowledge base described herein provides an intelligent system capable of assisting technicians in diagnosing problems and/or addressing problems using log files. Additional aspects and advantages of the example methods, apparatus, systems, and/or articles of manufacture are described in greater detail herein.

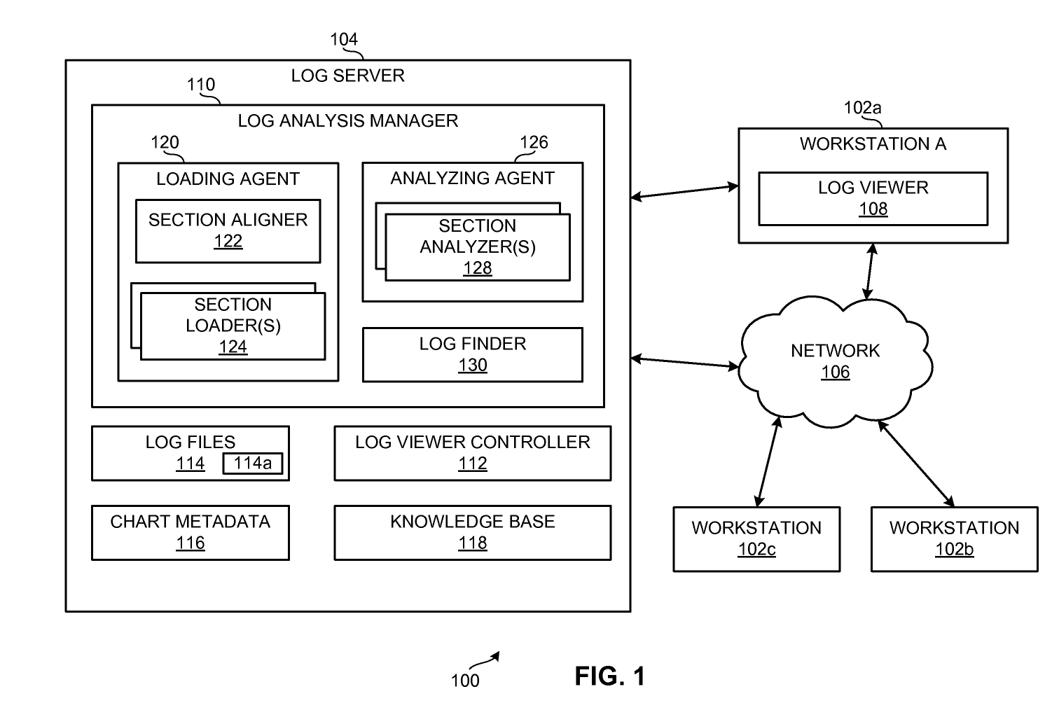

FIG. 1 is a block diagram of an example log analysis system 100 including a plurality of workstations 102a-c and a log server 104. The example workstations 102a-c may be any equipment (e.g., a personal computer, terminal, mobile device such as a smartphone, etc.) capable of executing software that permits users to interact with electronic data (e.g., data of one or more log files). For example, one or more of the workstations 102a-c may be implemented in association with a hospital information system (HIS), an electronic medical record system (EMR), a radiology information system (RIS), a lab information system 115, a picture archiving and communication system (PACS) 116, and/or any other type of computing system.

The example workstations 102a-c are in communication with each other and the log server 104 via a network 106. The network 106 may be implemented by, for example, the Internet, an intranet, a private network, a wired or wireless Local Area Network, a wired or wireless Wide Area Network, a cellular network, and/or any other suitable network. As described in greater detail below, the workstations 102a-c exchange information with the log server 104 to enable one or more technicians to perform analyses of log file(s).

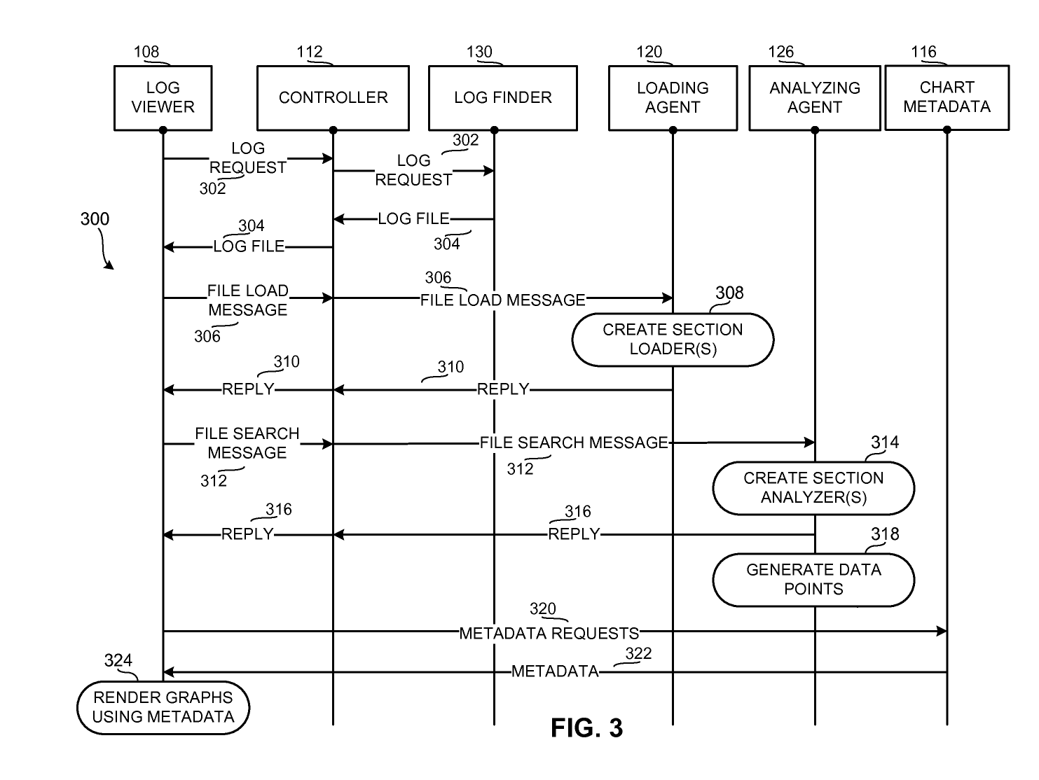

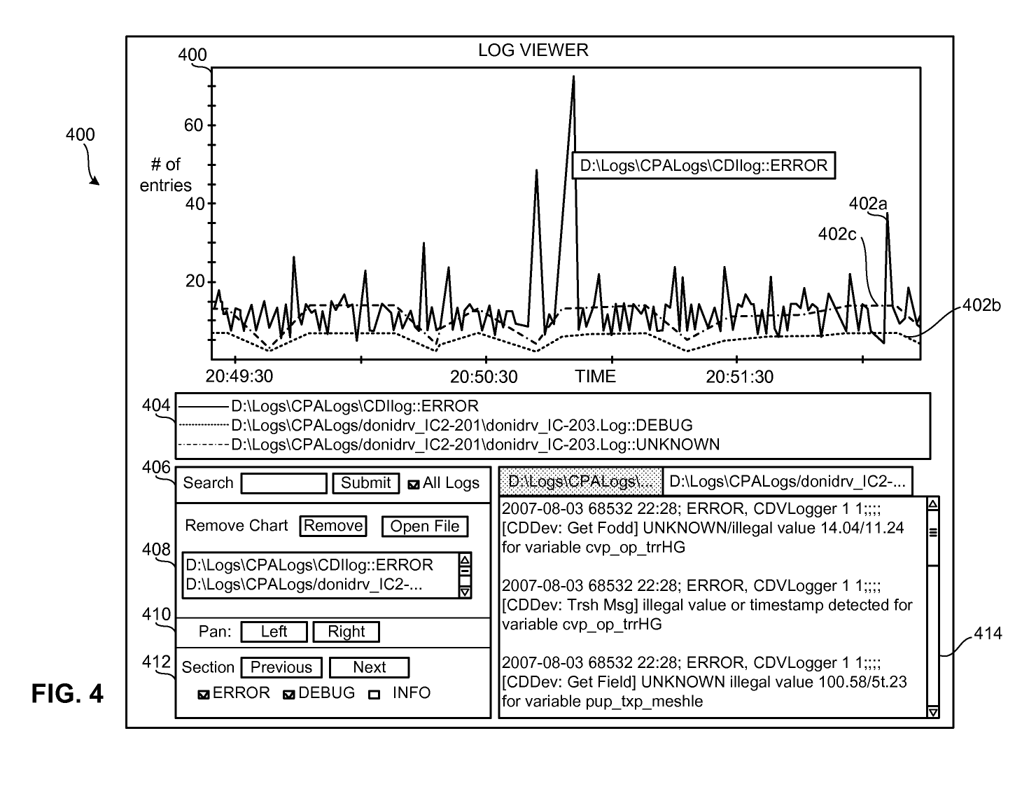

One or more of the workstations 102a-c (e.g., a first one of the workstations 102a as shown in FIG. 1) includes an example log viewer 108. Generally, the example log viewer 108 implements a graphical user interface (GUI) that enables a technician to interact with and/or otherwise utilize data from one or more log files. For example, the log viewer 108 receives log data from the example log server 104 and renders one or more graphical representations of the log data such that a user can readily identify areas of interest within the corresponding log file. Additionally or alternatively, the example log viewer 108 communicates information related to specific areas of the graphical representation(s) in response to an inquiry (e.g., placing a cursor over the specific areas of the graphical representation(s)) from the user. An example implementation of the log viewer 108 is described in detail below in connection with FIGS. 3 and 4.

The example log server 104 of FIG. 1 is implemented in a central computing system of a medical information system (not shown). For example, the example log server 104 is accessible (e.g., via the network 106) by a network of machines, such as the workstations 102a-c, which log onto the log server 104 using any suitable communication technique and/or protocol. The example log server 104 can be implemented in additional or alternative types of systems and can be configured as a dedicated server (e.g., a server having the sole purpose of the log analyses described herein) and/or as a component of another server and/or cluster of servers.

The example log server 104 of FIG. 1 includes a log analysis manager 110, a log viewer controller 112, log files 114, chart metadata 116, and a knowledge database 118. The example log analysis manager 110 includes a loading agent 120 having a section aligner 122 and one or more section loaders 124, an analyzing agent 126 having one or more section analyzers 128, and a log finder 130. While an example manner of implementing the log server 104 of FIG. 1 has been illustrated in FIG. 1, one or more of the elements, processes and/or devices illustrated in FIG. 1 may be combined, divided, re-arranged, omitted, eliminated and/or implemented in any other way. Further, the example log analysis manager 110, the example log viewer controller 112, the example log files 114, the example chart metadata 116, the example knowledge database 118, the example loading agent 120, the example section aligner 122, the example section loader(s) 124, the example analyzing agent 126, the example section analyzer(s) 128, the example log finder 130, and/or, more generally, the example log server 104 of FIG. 1 may be implemented by hardware, software, firmware and/or any combination of hardware, software and/or firmware. Thus, for example, any of the example log analysis manager 110, the example log viewer controller 112, the example log files 114, the example chart metadata 116, the example knowledge database 118, the example loading agent 120, the example section aligner 122, the example section loader(s) 124, the example analyzing agent 126, the example section analyzer(s) 128, the example log finder 130, and/or, more generally, the example log server 104 of FIG. 1 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example log analysis manager 110, the example log viewer controller 112, the example log files 114, the example chart metadata 116, the example knowledge database 118, the example loading agent 120, the example section aligner 122, the example section loader(s) 124, the example analyzing agent 126, the example section analyzer(s) 128, the example log finder 130, and/or, more generally, the example log server 104 of FIG. 1 are hereby expressly defined to include a tangible medium such as a memory, DVD, CD, etc., storing the software and/or firmware. Further still, the example log analysis manager 110, the example log viewer controller 112, the example log files 114, the example chart metadata 116, the example knowledge database 118, the example loading agent 120, the example section aligner 122, the example section loader(s) 124, the example analyzing agent 126, the example section analyzer(s) 128, the example log finder 130, and/or, more generally, the example log server 104 of FIG. 1 may include one or more elements, processes and/or devices in addition to, or instead of, those illustrated in FIG. 1, and/or may include more than one of any or all of the illustrated elements, processes and devices.

The example log viewer controller 112 facilitates communication between the example log viewer 108 of the example workstations 102a and the example log analysis manager 110. As described in greater detail below in connection with the example sequence diagram of FIG. 3, the example log viewer controller 112 receives messages (e.g., requests) from the example log viewer 108 and conveys the same (e.g., after one or more formatting and/or conversion procedures) to the example log analysis manager 110. Additionally, the example log viewer controller 112 conveys data (e.g., replies to requests from the log viewer 108) from the log analysis manager 110 to the log viewer 108. The example log viewer controller 112 may also convey additional or alternative information (e.g., display instructions, software updates, etc.) between the example log viewer 108 and the example log analysis manager 110.

The log files 114 stored on the example log server 104 include log files associated with, for example, operations of one or more of the workstations 102a-c, operations of one or more programs and/or software installed on one or more of the workstations 102a-c, and/or operations of the log server 104. In the illustrated example of FIG. 1, the log files 114 may include different types of log files generated by different types of systems in different formats. The example log server 104 of FIG. 1 is capable of interpreting and/or processing differently formatted log data and storing the same in the log files 114. Thus, external systems generating log files (e.g., one or more programs of the workstations 102a-c) do not need to be altered to force a standardized log format. Rather, the example log server 104 is capable of receiving differently formatted log files and processing the same such that each type of log file can be utilized (e.g., by the log viewer 108) as described herein.

As described in detail below in connection with the example sequence diagram of FIG. 3, a technician using the example log viewer 108 can request one or more log files 114 from the log server 104. The example log finder 130, which is shown as part of the log analysis manager 110 in the example of FIG. 1 but may be implemented in additional or alternative components, receives the request(s) for the log files 114. In response, the example log finder 130 accesses the log files 114 using an indication (e.g., a tag or identification name and/or number) corresponding to the requested log file(s) 114 and retrieves the requested log file(s) therefrom. In some examples, the log finder 130 returns the requested log file(s) 114 to the log viewer 108.

Generally, the example loading agent 120 cooperates with the example analyzing agent 126 to, in part, generate information that can be used by, for example, the log viewer 108 to render graphical representations of the requested log files 114 and/or portions thereof. In particular, when one of the log files (shown in FIG. 1 with reference numeral 114a) is requested by the log viewer 108, the example loading agent 120 creates one or more section loaders 124. The example loading agent 120 assigns each of the section loader(s) 124 a portion of the requested log file 114a. The example section aligner 122 maintains the alignment or sequence of the log data between the portions of the log file 114a. Each of the section loader(s) 124 loads the portion assigned thereto into the example analyzing agent 126 in response to, for example, an inquiry into the respective portion of the log file 114a (e.g., by a technician focusing in on a corresponding portion of a graphical representation of the log file 114a using the example log viewer 108).

For each portion of the log file 114a loaded into the analyzing agent 126, the example analyzing agent 126 creates a section analyzer 128. Each of the example section analyzer(s) 128 analyzes the portion of the log file 114a loaded thereto and generates data reflective of the information in that portion of the log file 114a. In particular, the example section analyzer(s) 128 generate data points to be used in the graphical representations described herein (e.g., the example graphs 402a-c of FIG. 4). The section analyzer(s) 128 may be configured to analyze the log files 114 in different manners and/or for different types of information. In the illustrated example, the section analyzer(s) 128 determine a number of occurrences of one or more types of error messages in the log file 114a. For instance, a first one of the section analyzer(s) 128 in the illustrated example is configured to determine how many times a first type of log entry (e.g., an error message) occurred in a first portion of the log file 114a (e.g., the portion of the log file 114a loaded into the analyzing agent 126 by a first one of the section loader(s) 124). In such an instance, a second one of the section analyzer(s) 128 in the illustrated example is configured to determine how many times the first type of log entry (e.g., the error message) occurred in a second portion of the log file 114a (e.g., the portion of the log file 114a loaded into the analyzing agent 126 by a second one of the section loader(s) 124). Further, a third one of the section analyzer(s) 128 in the illustrated example is configured to determine how many times a second type of log entry (e.g., a debug message) occurred in a the first portion of the log file 114a (e.g., the portion of the log file 114a loaded into the analyzing agent 126 by the first one of the section loader(s) 124). Further, a fourth one of the section analyzer(s) 128 in the illustrated example is configured to determine how many times the second type of log entry (e.g., the debug message) occurred in the second portion of the log file 114a (e.g., the portion of the log file 114a loaded into the analyzing agent 126 by the second one of the section loader(s) 124).

The data points generated by the example section analyzer(s) 128 are stored as chart metadata 116 in the example log server 104 of FIG. 1. Thus, the example chart metadata 116 of FIG. 1 includes data points (and timestamps associated therewith) to be used by the example log viewer 108 to render graphical representations of the requested log file 114a and the information thereof. In the illustrated example, the data points of the chart metadata 116 include numbers of occurrences of certain log entries (e.g., error messages, debug messages, etc.) occurring at different times in the requested log file 114a.

As the example log viewer 108 alters which portion of the log file 114a is presented to the technician (e.g., as manipulated by the technician), the data points corresponding to the current portion of the log file are generated by the section analyzer(s) 128 and/or retrieved from the chart metadata 116 (e.g., when the section analyzer(s) 128 have already generated that data and stored a copy thereof).

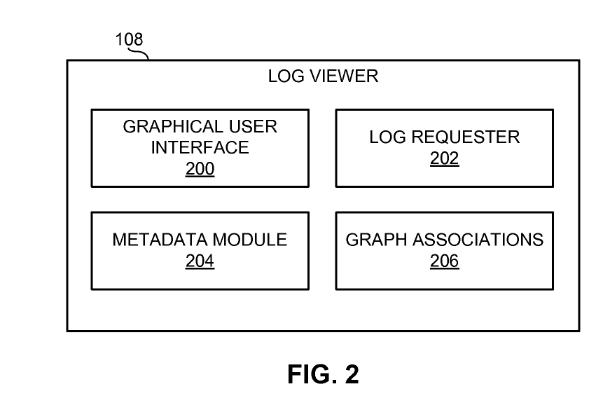

FIG. 2 is a block diagram of an example apparatus that may be used to implement the example log viewer 108 of FIG. 1. The example log viewer 108 of FIG. 2 includes a graphical user interface 200, a log requester 202, a metadata module 204, and graph associations 206. While an example manner of implementing the example log viewer 108 of FIG. 1 has been illustrated in FIG. 2, one or more of the elements, processes and/or devices illustrated in FIG. 2 may be combined, divided, re-arranged, omitted, eliminated and/or implemented in any other way. Further, the example graphical user interface 200, the example log requester 202, the example metadata module 204, the example graph associations 206, and/or, more generally, the example log viewer 108 of FIG. 2 may be implemented by hardware, software, firmware and/or any combination of hardware, software and/or firmware. Thus, for example, any of the example graphical user interface 200, the example log requester 202, the example metadata module 204, the example graph associations 206, and/or, more generally, the example log viewer 108 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example graphical user interface 200, the example log requester 202, the example metadata module 204, the example graph associations 206, and/or, more generally, the example log viewer 108 of FIG. 2 are hereby expressly defined to include a tangible medium such as a memory, DVD, CD, etc., storing the software and/or firmware. Further still, the example graphical user interface 200, the example log requester 202, the example metadata module 204, the example graph associations 206, and/or, more generally, the example log viewer 108 of FIG. 2 may include one or more elements, processes and/or devices in addition to, or instead of, those illustrated in FIG. 2, and/or may include more than one of any or all of the illustrated elements, processes and devices.

The example graphical user interface (GUI) 200 of FIG. 2 can be implemented in any suitable manner capable of providing information to a technician and receiving information and/or instructions therefrom. As described herein, the example log viewer 108 enables technicians to readily discern areas of concern within a log file, indications of certain problems and/or causes of the problems, etc. by rendering graphical representations of log file data. The example GUI 200 of FIG. 2 renders the graphical representations by interpreting information related to the log files 114 of FIG. 1 and/or any other log files. For example, the GUI 200 is capable of receiving data points from the chart metadata 116 of FIG. 1 and generating one or more graphs based thereon.

Furthermore, the example GUI 200 of FIG. 2 enables users to request one or more logs from, for example, the log server 104 of FIG. 1. In particular, the example GUI 200 receives a request from a user (e.g., in a field or from a list) for one or more log files and conveys the request, along with an identification of the requested log file(s), to the example log requester 202. The example log requester 202 communicates with the log server 104 (e.g., via the network 106) and/or, more specifically, the log finder 130 in the illustrated example of FIG. 1. The example log requester 202 provides an identifier associated with the requested log file(s) to the log finder 130 that, as described above, retrieves the requested log file(s) (if available) from the log files 114. The log requester 202 then receives the requested log file(s), which can be used by the example GUI 200 to display information associated therewith (e.g., a name(s) of the log file(s), source(s) of the log file(s), etc.).

The example metadata module 204 of FIG. 2 is configured to exchange information with the log server 104 and/or, more specifically, the chart metadata 116 in the illustrated example of FIG. 1. As described above, the chart metadata 116 includes data points that define the graphical representations to be displayed by the example GUI 200. When a user of the log viewer 108 changes a view of the graphical representations such that an additional or alternative portion of the log file data is to be displayed, the example metadata module 204 polls the example chart metadata 116 for the corresponding additional or alternative data points associated with the additional or alternative portion of the log file data. In some examples, those data points have already been communicated to the log viewer 108 (e.g., and stored in a local cache). In such instances, the metadata module 204 may forego polling the chart metadata 116 of the log server 104.

The example graph associations 206 enable a user to engage a portion of a graphical representation of a log file and, in response, to be presented with a corresponding section of the textual data of the log file. The graph associations 206 may be generated by the log viewer 108 by analyzing the log file(s) received from the log server 108 and/or the graph associations 206 may be included in the data points received from the chart metadata 116 of FIG. 1. As described below in connection with FIG. 4, the graphical representations in the illustrated example are presented with one axis representing time. Thus, in the illustrated example, clicking on a portion of the graphical representations causes the GUI 200 to reference to the graph associations 208 to determine a section of the log file corresponding to the clicked portion. In such instances, the example graph associations 206 provide the GUI 200 with a textual block of the log file, which the GUI 200 displays to the user. Thus, the example log viewer 108 and the example graph associations 206 thereof provide technicians rapid access to areas of interest within log files.

FIG. 3 is an example sequence diagram 300 illustrating example communications conveyed in the example log analysis system 100 of FIG. 1. In particular, the example sequence diagram 300 illustrates an example exchange of message between the example log viewer 108 of FIGS. 1 and/or 2 and the example log analysis manager 110 of the example log server 104 of FIG. 1. As shown in FIG. 3, the example log viewer 108 conveys (e.g., via the network 106) a log request 302 to the example log server 104. The log request 302 of the illustrated example is made by a technician using the log viewer 108 at the first workstation 102a wanting to view information related to the requested log file 114a from the log files 114. The example log viewer controller 112 receives the request 302. As described above, the log viewer controller 112 of FIG. 1 acts as an intermediary between the log viewer 108 and the log analysis manager 110 (e.g., by processing, converting, and/or otherwise processing electronic data or messages). The example log viewer 108 conveys the log request 302 to the example log finder 304. In response to receiving the log request 302, the example log finder 130 accesses the log files 114 using an indication (e.g., a tag or identification name and/or number conveyed with the log request 302) corresponding to the requested log file 114a and retrieves the requested log file 114a therefrom. The example log finder 130 then conveys the requested log file 114 to the log viewer 108 via the controller 112 (the requested log file 114a is labeled with reference numeral 304 in the example sequence diagram 300 of FIG. 3).

As the GUI 200 of the log viewer 108 loads the requested log file 114a, the log viewer 108 conveys a file load message 306 to the example loading agent 120 of the example log analysis manager 110 of FIG. 1. In response, the example loading agent 120 creates one or more section loaders 124 corresponding to the portions of the log file 114a (the creation of the section loader(s) 124 is labeled with reference numeral 308 in the example sequence diagram 300 of FIG. 3). As described above, the section loader(s) 124 are each assigned to a portion of the log file 114a (e.g., as different portions of the log file 114a are accessed and/or presented by the log viewer 108). Upon the successful generation of the section loader(s) 124, the example loading agent 120 conveys a reply 310 indicating the successful generation of the section loader(s) 124 to the log viewer 108 via the controller 112.

As the a user of the GUI 200 of the log viewer 108 searches and/or navigates through the log file 114a, different portions of the log file 114a are presented. To inform the log analysis manager 110 of such activity, the log viewer 108 sends a file search message 312 to the example analyzing agent 126. In the illustrated example, the analyzing agent 126 creates one or more section analyzers 128 to correspond to each of the portions of the log file 114a (e.g., as the portions of the log file 114a are loaded to the analyzing agent 126 by the section loader(s) 124). Upon the successful generation of the section analyzer(s) 128, the example analyzing agent 126 conveys a reply 316 indicating the successful generation of the section analyzer(s) 128 to the log viewer 108 via the controller 112. Furthermore, the example section analyzer(s) 128 generate the data points described above and store the same in the example chart metadata 116 of FIG. 1 (the generation of the data points is labeled with reference numeral 318 in the example sequence diagram 300 of FIG. 3). In the illustrated example, the section analyzer(s) 128 analyze a portion of the log file 114a and generate data points corresponding to periods of time indicative of a number of occurrences of a certain type of log entry during the periods of time. Thus, an example section analyzer 128 may generate a set of data points indicative of how many occurrences of a first type of log entry (e.g., an error message, a debug message, an information message, an unknown value message, etc.) are in the log file 114a over a plurality of time periods. The example section analyzer(s) 128 can generate additional or alternative types of data points as the example described herein are meant for purposes of illustration.

As a user operates the example log viewer 108 (e.g., to view different portions of the log file 114a and/or the graphical representations thereof), the example metadata module 204 of the log viewer 108 polls or sends repeated requests 320 to the chart metadata 116 of the log server 104. The chart metadata 116 (which is labeled with reference numeral 322 in the example sequence diagram 300 of FIG. 3) is conveyed to the log viewer 108 as the data points of the chart metadata 116 are used by the GUI 200 of the log viewer 108 to generate the graphical representations of the log file information described herein (e.g., graphs indicating a number of occurrences of certain types of log entries over a certain period of time). The rendering of such graphical representations is labeled with reference numeral 324 in the example sequence diagram 300 of FIG. 3.

FIG. 4 is a screenshot 400 associated with an example implementation of the example log viewer of FIGS. 1 and/or 2. In particular, the example screenshot 400 illustrates an example implementation of the example GUI 200 of FIG. 2. Generally, the example GUI 200 of FIG. 4 includes a graph section 400 having a plurality of graph 402a-c. Each of the graphs 402a-c is a representation of the data points generated by corresponding section analyzer(s) 128. In the illustrated example, the data points indicate a number of occurrences of certain log entries (shown as the vertical axis in the graph section 400) over time (shown as the horizontal axis in the graph section 400). For example, a first one of the graphs 402a includes a spike in the number of occurrences of an error message around the 20:50:50 units of time.

The screenshot 400 includes a legend section 404 to indicate which type of line is used to represent different graphs. In the illustrated example, a solid line represents the number of occurrences of a first type of log entry, which is an error message; a continuously dotted line represents the number of occurrences of a second type of log entry, which is a debug message; and a dotted and dashed line represents the number of occurrences of a third type of log entry, which is an unknown message.

The example screenshot 400 includes a search field 406 that allows one or more log files to be searched. In particular, the search field 406 includes a blank field into which a user may type a string to be used in a search of a currently displayed log file, all requested log files, and/or any other designated log file(s). The example screenshot 400 also includes a graph removal section 408. The example graph editing section 408 enables a user to select one of the graphs from a list or menu for removal from the graph section 400. Additionally, the graph editing section 408 includes an ‘open file’ button to enable a user to select a graph from a list or menu for addition to the graph section 400.

The example screenshot 400 includes a pan section 410 to enable a user to navigate through the graphs 402a-c presented in the graph section 400. The example pan section 410 of FIG. 4 includes buttons that, when engaged, cause a different portion of the graphs 402a-c to be displayed. In some examples, the portions of the graphs 402a-c to be displayed in the graph section 400 can additionally or alternatively be controlled by other input devices, such as, for example, a scroll wheel on a mouse, arrow keys on a keyboard, etc. The example screenshot 400 also includes a section navigation section 412. The example section navigation section 412 enables a user to incrementally navigate to a previous or next section of the graphs 402a-c. Furthermore, the section navigation section 412 includes a plurality of checkboxes to enable a user to select which type of log entry can control the navigation from one section of the graphs 402a-c to another.

The example screenshot 400 includes a log file text box 414 capable of displaying the textual contents of a selected log file. In particular, the log file text box 414 displays portions of a selected log file corresponding to a selected or engaged portion of one of the graphs 402a-c. Thus, when a user places a cursor on a first portion of the first graph 402a and/or presses a button while the cursor is placed on the first portion of the first graph 402a, the log file text box 414 displays a section of the corresponding log file that is associated with the position at which the user places the cursor. In the illustrated example, the corresponding section of the log file is determined by referencing the example graph associations 206 described above in connection with FIG. 2. In the illustrated example of FIG. 4, when a user places a cursor on the first graph 402a at the spike (at approximately 20:50:50 in time) (e.g., because the spike indicates a portion of interest to a technician attempting to diagnose a problem using log file data), a text box appears in the graph section 400 to indicate which log file is represented by the first graph 402a. Additionally, the log file text box 414 is populated with a section of the log file (e.g., identified as corresponding to the clicked portion of the graph 402a in the graph associations 206) represented by the first graph 402a corresponding to the position of the cursor (e.g., the log entries timestamped at approximately 20:50:50).

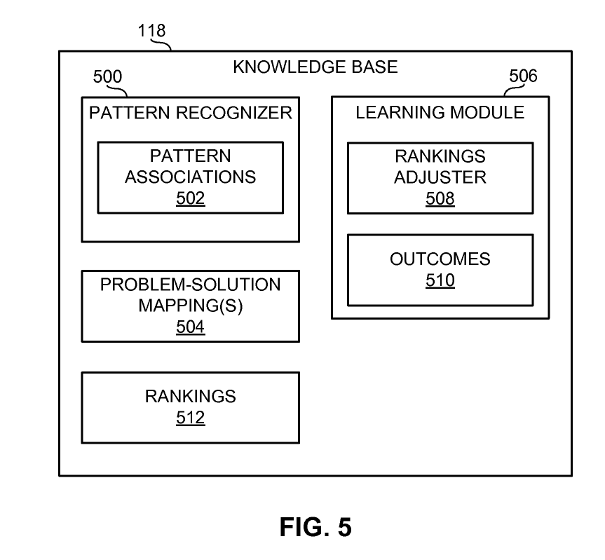

FIG. 5 is a block diagram of an example apparatus that may be used to implement the example knowledge database 118 of FIG. 1. The example knowledge base 118 of FIG. 5 includes a pattern recognizer 500 including pattern associations 502, problem-solution mapping(s) 504, a learning module 506 including a rankings adjuster 508 and outcomes 510, and rankings 512. While an example manner of implementing the knowledge database 118 of FIG. 1 has been illustrated in FIG. 5, one or more of the elements, processes and/or devices illustrated in FIG. 5 may be combined, divided, re-arranged, omitted, eliminated and/or implemented in any other way. Further, the example pattern recognizer 500, the example pattern associations 502, the example problem-solution mapping(s) 504, the example learning module 506, the example rankings adjuster 508, the example outcomes 510, the example rankings 512, and/or, more generally, the example knowledge base 118 of FIG. 5 may be implemented by hardware, software, firmware and/or any combination of hardware, software and/or firmware. Thus, for example, any of the example pattern recognizer 500, the example pattern associations 502, the example problem-solution mapping(s) 504, the example learning module 506, the example rankings adjuster 508, the example outcomes 510, the example rankings 512, and/or, more generally, the example knowledge base 118 of FIG. 5 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example pattern recognizer 500, the example pattern associations 502, the example problem-solution mapping(s) 504, the example learning module 506, the example rankings adjuster 508, the example outcomes 510, the example rankings 512, and/or, more generally, the example knowledge base 118 of FIG. 5 are hereby expressly defined to include a tangible medium such as a memory, DVD, CD, etc., storing the software and/or firmware. Further still, the example pattern recognizer 500, the example pattern associations 502, the example problem-solution mapping(s) 504, the example learning module 506, the example rankings adjuster 508, the example outcomes 510, the example rankings 512, and/or, more generally, the example knowledge base 118 of FIG. 5 may include one or more elements, processes and/or devices in addition to, or instead of, those illustrated in FIG. 5, and/or may include more than one of any or all of the illustrated elements, processes and devices.

The example pattern recognizer 500 is capable of analyzing a log file and/or portion(s) thereof to determine whether a pattern known to be associated with a particular problem and/or cause of a problem is present in the log file. In other words, the pattern recognizer 500 considers one or more conditions (e.g., log entries) of an environment or system and identifies a likely state of the environment or system. In the illustrated example, this identification can be implemented using, for example, a Bayesian belief network. The Bayesian belief network can identify, for example, a likely cause of a problem given one or a set of symptoms or patterns (e.g., one or more log entries and/or patterns in the log entries). In the illustrated example, the known patterns are stored in the pattern associations 502. The pattern recognizer 500 can compare patterns in a particular log file or the data points generated by the corresponding section analyzer(s) 128 and stored in the chart metadata 116 to patterns in the pattern associations 502. If the patterns of the log file and/or data points significantly (e.g., within a threshold) match one or more of the patterns of pattern association 502, the matching pattern association(s) 502 indicate a problem and/or a cause of a problem known to be associated with the recognized pattern. The problem and/or cause of a problem indicated in the matching pattern association(s) 502 can be conveyed to a user of the log viewer 108 (e.g., in a pop-window displayed in association with the corresponding portion of the graph associated with the log file). Initially, the pattern associations 502 include a preliminary set of associations. Over time, as technicians use the example knowledge base 118 described herein (e.g., in association with the log viewer 108), the example pattern associations can be updated, edited, and/or otherwise altered to improve the accuracy and/or depth of the recognition of problem(s) and/or causes thereof.

When, as in the illustrated example, the generation and updating of the pattern associations 502 are implemented through the use of a Bayesian belief network, an acydic graph can be used for the belief network. In such instances, nodes of the graph represent problems and symptoms (e.g., as reflected by the log entries) and the edges of the graph represent conditional dependenc(ies) of the two. For example, a log entry corresponding to frequent waiting with no forward calculation progress may be a symptom and a server not responding could be a proposed problem. The example network described herein for the pattern associations 502 can be used to identify, given the fact that the calculation is not progressing, one or more likely causes (e.g., ranked in order of likelihood). Every node in the graph would store its conditional probability for every possible cause on which it was dependent. These probabilities may be adjusted over time (e.g., from the initial set of pattern associations 502) to more accurately reflect actual results. For example, if technicians using the example knowledge base 118 observe that ninety percent of “no calculation progress” patterns coincided with an unresponsive server, the probability of the “non-responsive server” as a corresponding problem can be adjusted to reflect a ninety percent likelihood. As more symptoms or patterns of log entries are observed and reported back to the example knowledge base 118, this probability and the probability of the other problems (e.g., dependent problems based on the structure of the Bayesian belief network) are adjusted dynamically, resulting in improved accuracy over time. The highest ranked problem in a pattern map or graph corresponds to the problem that has the highest likelihood given a symptom or set of symptoms in a log environment. Any suitable technique(s) can be used to calculate the probability values for various nodes in the network.

The example problem-solution mapping(s) 504 of FIG. 5 include a plurality of known problems and potential solution(s) to those problems. In other words, the example problem-solution mapping(s) 504 can be referenced when, for example, a known problem is identified by the example pattern recognizer 500 to provide a suggested solution (e.g., a corrective course of action, an additional test to run, etc.) to the identified problem. One or more suggested solutions for an identified problem can be conveyed to a user of the example log viewer 108 (e.g., in a pop-window displayed in association with the corresponding portion of the graph associated with the log file). Initially, the problem-solution mapping(s) 504 include a preliminary set of problems and corresponding solutions. Over time, as technicians use the example knowledge base 118 described herein (e.g., in association with the log viewer 108), the example problem-solution mapping(s) 504 can be updated, edited, and/or otherwise altered to improve the accuracy and/or depth of the solutions suggested for problem(s).

In the illustrated example, similar to the pattern associations 502 described above, the problem-solution mapping(s) 504 are implemented using a Bayesian belief network. In such instances, the belief network is reflected in a directed acydic graph having nodes representing the problems (e.g., as indicated by log entries) and edges representing conditional dependenc(ies) to the problems. For example, problems that can, in turn, cause other problems, would have and edges from the causing problem to the caused problem. Problems are “root causes” that would have a known solution (e.g., server power being lost has a solution of turning on the server; memory overflow in a program has a solution of checking for memory leaks, etc.). The graph is then used to identify the probability that server power was lost, given that the server has stopped responding to remote calls. Each node in the graph would store a corresponding conditional probability for each possible cause on which it was dependent. These probabilities can be are adjusted (e.g., according to feedback from technician(s)) to reflect actual results. For example, if nine out of ten instances of a log entry corresponding with an unresponsive server was caused by the server being powered off, the probability of the power being off as a root cause is adjusted be ninety percent. As more problems are observed and reported back to the system by technician(s), this probably and the probability of the other root cases would be adjusted dynamically, resulting in improved accuracy over time. The highest ranked solution (e.g., in the problem solution mapping(s) 504 is the solution having the highest likelihood given a problem or set of problems in a log environment. Any suitable technique(s) can be used to calculate the probability values for various nodes in the network.

In the illustrated example of FIG. 5, the example rankings 512 are confidence levels assigned to the pattern associations 502 and the problem-solution mapping(s) 504. In some examples, the rankings 512 may be associated with additional or alternative information provided by and/or stored in association with the example knowledge base 118. As technicians utilize the pattern recognizer 500 and/or the problem-solution mapping(s) 504 of the knowledge base 118, the technicians provide feedback regarding the accuracy of the pattern associations 502 and/or the suggested solutions of the problem-solution mapping(s) 504. The feedback (e.g., a score, grade, etc.) is compiled in the rankings 512 to indicate a performance level of the pattern associations 502 and/or the suggested solutions of the problem-solution mapping(s) 504. The pattern recognizer 500 and/or the problem-solution mapping(s) 504 may consider the rankings 512 in conveying a suggestion or recognition to a user. For example, the pattern recognizer 500 may convey a certain amount of possible problems and/or causes thereof such as, for example, the three highest ranked possible problems and/or causes thereof according to the rankings 512. Additionally or alternatively, the problem-solution mapping(s) 504 may convey a certain amount of suggested solutions such as, for example, the three highest ranked suggested solutions for an identified problem according to the rankings 512. In the illustrated example, when the pattern associations 502 and/or the problem-solution mapping(s) 504 are implemented using the Bayesian belief networks, the rankings 512 correspond to the conditional probabilities associated with each node of the acydic graph.

Generally, the example learning module 506 of FIG. 5 enables the knowledge base 118 to be updated as technicians and/or other users utilize the knowledge base 118. By receiving information from technicians using the knowledge base 118 and updating the components thereof, the example knowledge base 118 of the illustrated example reflects a collective knowledge and/or expertise of the plurality of technicians using the knowledge base 118. Further, the patterns recognition and/or solution suggestion operations described herein are improved by the example learning module 506 by, for example, removing inaccurate patterns, solutions, and/or any other information.

In the illustrated example of FIG. 5, the learning module 506 receives results of technicians' use of the identified problems (e.g., by the pattern recognizer 500) and/or the suggested solution (e.g., from the problem-solution mapping(s) 504) and stores the results in the outcomes 510. The example rankings adjuster 508 detects newly stored outcomes 510 and adjusts the rankings 512 accordingly. That is, if the results of a new entry in the outcomes 510 are positive, the example rankings adjuster 508 improves (e.g., increases) the confidence level of the corresponding one or more of the rankings 512. On the other hand, if the results of the new entry in the outcomes 510 are negative, the example rankings adjuster 508 worsens (e.g., decreases) the confidence level of the corresponding one or more of the rankings 512. The amount of the adjustment made by the ranking adjuster 508 may depend on a degree associated with the feedback provided by the technician(s). For example, the technicians may be able to score (e.g., positively or negatively) the potential problem(s), cause(s) of problem(s), and/or suggested solution(s). In such instances, the degree of the score of the feedback may influence how the rankings adjuster 508 adjusts the rankings 512.

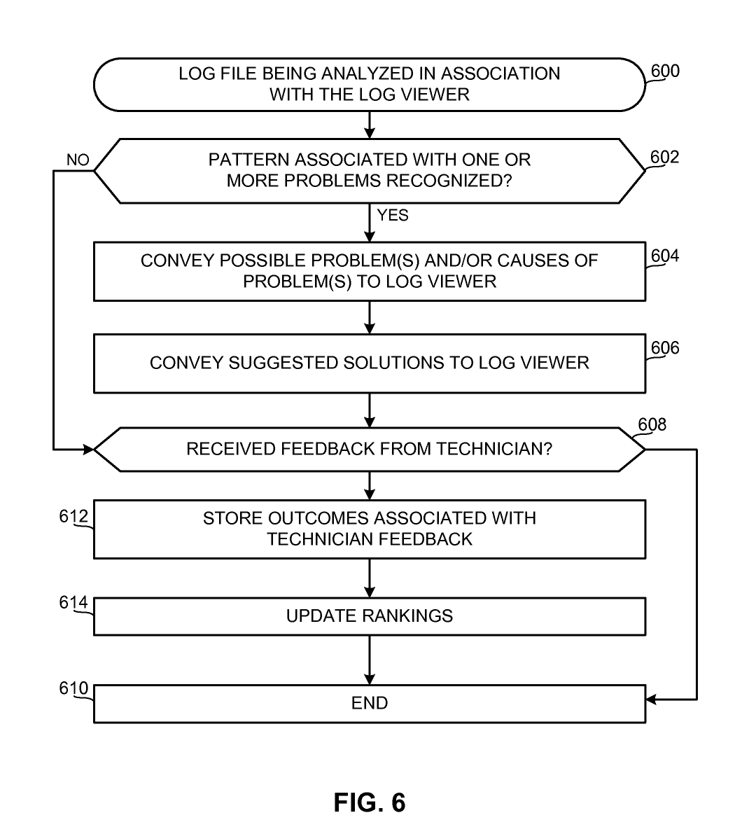

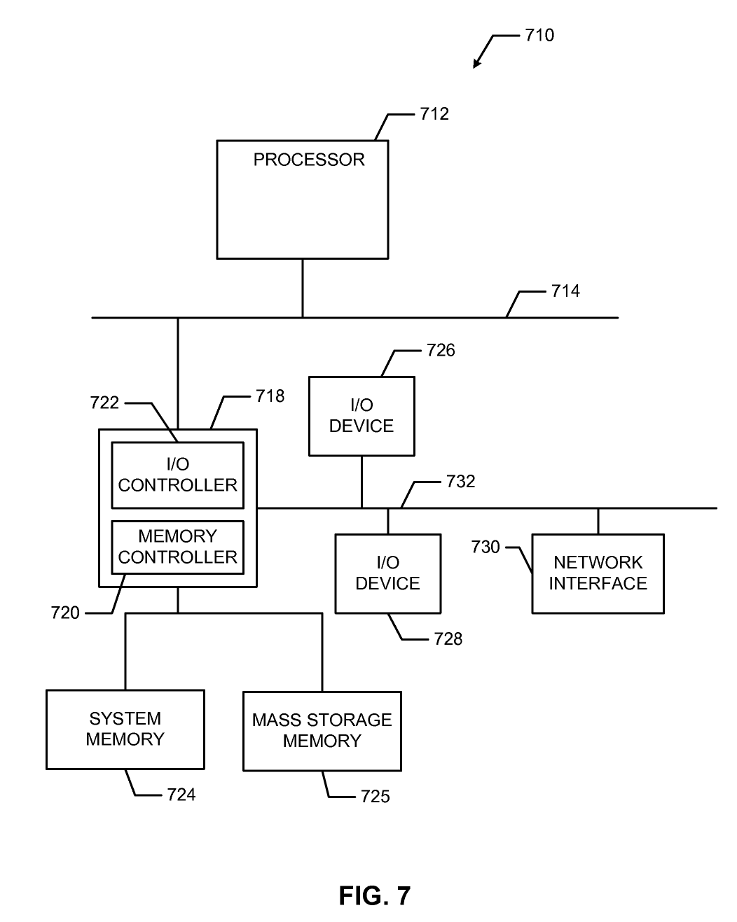

FIG. 6 is a flow diagram representative of example machine readable instructions that may be executed to implement the example knowledge base 118 of FIGS. 1 and/or 5. The example processes of FIG. 6 may be performed using a processor, a controller and/or any other suitable processing device. For example, the example processes of FIG. 6 may be implemented in coded instructions stored on a tangible medium such as a flash memory, a read-only memory (ROM) and/or random-access memory (RAM) associated with a processor (e.g., the example processor 712 discussed below in connection with FIG. 7). Alternatively, some or all of the example processes of FIG. 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 6 may be implemented manually or as any combination(s) of any of the foregoing techniques, for example, any combination of firmware, software, discrete logic and/or hardware. Further, although the example processes of FIG. 6 are described with reference to the flow diagram of FIG. 6, other methods of implementing the processes of FIG. 6 may be employed. For example, the order of execution of the blocks may be changed, and/or some of the blocks described may be changed, eliminated, sub-divided, or combined. Additionally, any or all of the example processes of FIG. 6 may be performed sequentially and/or in parallel by, for example, separate processing threads, processors, devices, discrete logic, circuits, etc.

At the onset of the example of FIG. 6, a log file (e.g., the requested log file 114a of FIG. 1.) is being analyzed by one or more technicians using the example log viewer 108 of FIGS. 1 and/or 2 (block 600). The example pattern recognizer 500 of the example knowledge base 118 of FIG. 5 determines whether one or more portions of the log file 114a (e.g., portions being currently displayed on the GUI 200 of the log viewer 108) substantially match one of the patterns of the pattern associations 502 (block 602). If the pattern recognizer 500 identifies one or more matches, the example pattern recognizer 500 conveys the corresponding problem(s) and/or cause(s) of problem(s) according to the pattern associations 502 to the log viewer 108 (block 604). Further, when a problem and/or cause of a problem is identified by the pattern recognizer 500, the problem-solution mapping(s) 504 are also referenced and any potential solution to the identified problem(s) are conveyed to the log viewer 108 (block 606).

Referring back to block 602, when the pattern recognizer 500 does not recognize a pattern in the log file 114a, or after any suggested solution(s) are conveyed to the log viewer 108 at block 608, the example learning module 506 determines whether any technician supplied feedback for the possible problem(s), cause(s) of problem(s), and/or suggested solution(s) (block 608). If no feedback was provided, the example process of FIG. 6 ends (block 610). Otherwise, if feedback was provided, the example learning module 506 stores the feedback in the outcomes 510 (block 612). The example rankings adjuster 508 detects the addition of feedback to the outcomes 510 and adjusts the rankings 512 according to the nature (e.g., positive or negative) of the feedback and/or a degree of the feedback. The example process of FIG. 6 then ends (block 610).

FIG. 7 is a block diagram of an example processor system 710 that may be used to implement the apparatus and methods described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for use with log file analyses, comprising:
generating, by a processor, a plurality of data points by analyzing information in a log file;
displaying one or more graphical representations of the data points; and
in response to detecting an engagement of a first portion of a first one of the graphical representations, identifying a section of the log file corresponding to the engaged first portion and displaying the section of the log file in association with the graphical representations.

2. A computer implemented method as defined in claim 1, wherein generating the data points by analyzing the one or more portions of the log file comprises determining a number of occurrences of a first type of log entry occurring over a period of time.

3. A computer implemented method as defined in claim 1, wherein displaying the section of the log file in association with the graphical representations comprises displaying the section of the log file in a text box adjacent a graph section including the graphical representations.

4. A computer implemented method as defined in claim 1, further comprising analyzing the data points to determine whether a known pattern is present in the log file.

5. A computer implemented method as defined in claim 4, further comprising identifying a problem or a cause of a problem known to be associated with the known pattern when the known pattern is present in the log file, and conveying the identified problem or the cause of the problem to a technician using the log file.

6. A computer implemented method as defined in claim 5, further comprising receiving feedback from the technician related to the identified problem or the cause of the problem and updating rankings associated with the known pattern according to the feedback.

7. A computer implemented method as defined in claim 5, further comprising identifying a potential solution for the identified problem or the cause of the problem and conveying the potential solution to a technician

8. A computer implemented method as defined in claim 7, further comprising receiving feedback from the technician related to the potential solution and updating rankings associated with the known pattern according to the feedback.

9. A computer implemented method as defined in claim 7, wherein updating the rankings associated with the known pattern according to the feedback comprises updating a conditional probability associated with a node of a Bayesian belief network.

10. A tangible machine readable medium having instructions stored thereon that, when executed, cause a machine to:
generate a plurality of data points by analyzing information in a log file;
display one or more graphical representations of the data points; and
in response to detecting an engagement of a first portion of a first one of the graphical representations, identify a section of the log file corresponding to the engaged first portion and displaying the section of the log file in association with the graphical representations.

11. A tangible machine readable medium as defined in claim 9 having instructions stored thereon that, when executed, cause a machine to generate the data points by analyzing the one or more portions of the log file by determining a number of occurrences of a first type of log entry occurring over a period of time.

12. A tangible machine readable medium as defined in claim 9 having instructions stored thereon that, when executed, cause a machine to display the section of the log file in association with the graphical representations by displaying the section of the log file in a text box adjacent a graph section including the graphical representations.

13. A tangible machine readable medium as defined in claim 9 having instructions stored thereon that, when executed, cause a machine to analyze the data points to determine whether a known pattern is present in the log file.

14. A tangible machine readable medium as defined in claim 12 having instructions stored thereon that, when executed, cause a machine to identify a problem or a cause of a problem known to be associated with the known pattern when the known pattern is present in the log file, and conveying the identified problem or the cause of the problem to a technician using the log file.

15. A tangible machine readable medium as defined in claim 13 having instructions stored thereon that, when executed, cause a machine to receive feedback from the technician related to the identified problem or the cause of the problem and updating rankings associated with the known pattern according to the feedback.

16. A tangible machine readable medium as defined in claim 13 having instructions stored thereon that, when executed, cause a machine to identify a potential solution for the identified problem or the cause of the problem and conveying the potential solution to a technician

17. A tangible machine readable medium as defined in claim 15 having instructions stored thereon that, when executed, cause a machine to receive feedback from the technician related to the potential solution and updating rankings associated with the known pattern according to the feedback.

18. An apparatus for use with log file analyses, comprising:
a module to obtain a plurality of data points from a server having one or more section analyzers that generate the data points by analyzing information in a log file;
a graphical user interface to display one or more graphical representations of the data points; and
one or more graph associations to enable an engagement of a first portion of a first one of the graphical representations to cause an identification of a section of the log file corresponding to the engaged first portion and a display of the section of the log file in association with the graphical representations.

19. An apparatus as defined in claim 17, further comprising a knowledge base to analyze the data points to determine whether a known pattern is present in the log file, and one or more pattern associations including a problem or a cause of a problem associated with the known pattern, wherein the problem or the cause of the problem is conveyed to a technician when the known pattern is recognized in the log file.

20. An apparatus as defined in claim 19, wherein the knowledge base includes a Bayesian belief network configured to reflect the pattern associations by associating one or more nodes of the Bayesian belief network with one or more problems and associating one or more edges of the Bayesian belief network with one or more conditional dependencies among the problems and symptoms, and wherein the conditional dependencies are updated according to feedback received from one or more users of the knowledge base.
